(19) United States
(12) Patent Application Publication
(10) Pub. No.: US 2026/0249320 A1
(43) Pub. Date: Aug. 27, 2026

(54) DISPENSING SYSTEM, DISPENSING OUTLET AND CARTRIDGE

(71) Applicant: medmix Switzerland AG, Haag (CH)

(72) Inventors: Nicolas DELIAVAL, Buchs (CH); Emanuel BASTOS, Buchs (CH); Josef MOSER, Unterkulm (CH)

(21) Appl. No.: 18/862,091

(22) PCT Filed: May 16, 2023
(86) PCT No.: PCT/EP2023/063168

§ 371 Date: Oct. 31, 2024

(30) Foreign Application Priority Data
May 19, 2022 (EP) 22174250.5
Nov. 8, 2022 (EP) 22206190.5
Nov. 18, 2022 (EP) 22208397.4
Dec. 20, 2022 (EP) 22214952.8
Mar. 13, 2023 (EP) 23161422.3

(51) Int. Cl. B05C 17/01; A61C 5/64; B05C 17/005

(52) U.S. Cl. CPC B05C 17/0146; A61C 5/64; B05C 17/00506; B05C 17/00516; B05C 17/00566

(57) ABSTRACT

A dispensing system includes a dispensing outlet, a valve element and a cartridge having a cartridge outlet with a longitudinal axis extending along the cartridge outlet. The valve element is slideably arranged at an interface between the cartridge outlet and the dispensing outlet in a direction transverse to the longitudinal axis. The dispensing outlet is insertable into the interface to slide the valve element.

### CROSS-REFERENCE TO RELATED APPLICATION

This application is a U.S National Stage application of International Application No. PCT/EP 2023/063168, filed May 16, 2023, which claims priority to European Application No. 22174250.5, filed May 19, 2022, European Application No. 22206190.5, filed Nov. 8, 2022, European Application No. 22208397.4, filed Nov. 18, 2022, European Application No. 22214952.8, filed Dec. 20, 2022, European Application No. 2316422.3, filed Mar. 13, 2023, the contents of each of which are hereby incorporated by reference.

### BACKGROUND

### Technical Field

The present disclosure relates to a dispensing system, to a dispensing outlet for use in a dispensing system and to a cartridge for use in a dispensing system. The dispensing system comprising a dispensing outlet, a valve element and a cartridge having a cartridge outlet with a longitudinal axis extending along the cartridge outlet, wherein the valve element is slideably arranged at an interface between the cartridge outlet and the dispensing outlet in a direction transverse to the longitudinal axis, the dispensing outlet being insertable into the interface for sliding the valve element.

### Background Information

Conventional dispensing systems exists in a multitude of forms that can be used in a plethora of applications ranging from dental applications, medical applications, veterinary applications to industrial applications and the like.

The dispensing systems typically have an outlet that can be connected to a cartridge in order to guide material stored in the cartridge to a point of application via the outlet. If two-component materials, such as adhesives, paints, molding materials, impression materials and the like are to be dispensed, the outlet portion of the dispensing system typically comprises a mixer to mix the two-components for the purpose of more or less ideal dispensing.

Frequently the dispensing systems are composed of plastic parts and specifically the outlets, i.e. the mixers, are single use parts that are discarded after every use. When the outlets are discarded, the material to be dispensed that remains also contributes to the waste material.

Following use of the dispensing system and discarding of the dispensing system, the material remaining in the cartridge is stored in the cartridge for further use.

### SUMMARY

It is an object of the disclosure to provide a dispensing system by which a longevity of the material stored in the dispensing system can be improved. It is a further object of the disclosure to provide a dispensing system that is simple to manufacture and that is reliable in use. It is yet a further object to reduce the amount of waste associated with the dispensing system.

This object is satisfied by the subject matter disclosed herein.

Such a dispensing system comprises a dispensing outlet, a valve element and a cartridge having a cartridge outlet with a longitudinal axis extending along the cartridge outlet, in particular in a direction of dispensing material from the dispensing outlet, wherein the valve element is slideably arranged at an interface between the cartridge outlet and the dispensing outlet in a direction transverse to the longitudinal axis, with the valve element being configured to open and close the cartridge outlet for dispensing material therefrom, and wherein a part of the dispensing outlet is insertable into the interface, in particular for the sliding, i.e. entraining, of the valve element in the direction transverse to the longitudinal axis, e.g. from the closed position into the open position of the valve element, wherein especially after removal of the dispensing outlet the valve element is automatically shifted from the open position back into the closed position for sealing off the cartridge outlet.

By such a dispensing system an opening and closing of the valve element can thus be reliably ensured increasing the lifetime of material stored in the cartridge.

In this connection it should be noted that the valve element can be shifted from a closed position when no dispensing outlet is attached to an open position on attachment of the dispensing outlet in order to permit a material stored in the cartridge to be dispensed from the cartridge. Following use of the cartridge and removal of the cartridge outlet, the valve element is slid back into the closed position for closing the cartridge. In this way the material stored in the cartridge can be stored for longer periods of time.

By providing a sliding valve element rather than a rotating valve element a force applied for opening and closing of the valve element can be concentrated in one direction enabling a more reliable opening and closing of the cartridge. This means that the sliding valve element does not rotate on being moved.

In this connection it should be noted that the dispensing outlet can also be referred to as a static or dynamic mixing tip.

In this connection it should further be noted that the cartridge outlet comprises the outlet passages from respective cartridge chambers of the cartridge and is the part of the cartridge configured to be connected to a dispensing outlet.

In this connection it should further be noted that the interface comprises those parts of the cartridge outlet and the dispensing outlet that are configured to cooperate with one another to attach the dispensing outlet to the cartridge outlet.

It should further be noted that the cartridge can have pistons and/or a plunger arranged therein for dispensing material via the dispensing system in an as simple as possible manner.

As discussed in the foregoing the valve element is thus able to slide transversely relative to the cartridge from the closed position to the open position and vice versa.

Following the transverse sliding of the valve element relative to the cartridge from the closed position into the open position, the dispensing outlet can be locked to the cartridge outlet against a movement along the longitudinal axis. Likewise once the valve element is moved relative to the cartridge from the open position into the closed position, the dispensing outlet can be unlocked for a movement along the longitudinal axis and in this way out of engagement with the cartridge.

The valve element may not be removable from the interface. In this connection it should be noted that the valve element is not removable during normal use of the dispensing system. It can, however, be possible to remove the valve element through the use of tools or if excessive force is applied which would lead to a destruction of the cartridge outlet.

The valve element may only slide relative to the interface along, preferably only, one axis. In this way one can control the direction in which the valve is moved between the open and closed position and vice versa.

At least one part of the dispensing outlet can be insertable into valve element. In this way the components can cooperate with one another to prevent leaks of material between the cartridge outlet and the dispensing outlet to avoid contamination therebetween.

The at least one part can comprise one or more inlet passages and/or wings. The material can be conducted in such inlet passages from the cartridge to a mixing element, if provided, and an outlet of the dispensing outlet.

The dispensing outlet can comprise a cover disc covering the interface. In this way one can avoid contamination, such as e.g. dust or expelled mixed material, from reaching the components of the interface if this were to drop from an outlet of the dispensing outlet.

The dispensing outlet can further comprises a collar. Such a collar can further increase the protection against contamination.

The collar can at least partly surround the interface and the cartridge outlet. This is a simple to manufacture extra level of protection against contamination.

The collar can at least partly surround the interface and can be arranged at least partly within the cartridge outlet. In this way an as compact as possible assembly can be realised.

The valve element can comprise an elongate plate with one or more throughbores. Such a valve element is simple to manufacture and can ensure a simple assembly with the cartridge.

The one or more throughbores can align with the cartridge outlet to open the cartridge outlet for dispensing, i.e. once the valve element is shifted into the open position the one or more throughbores can align with the cartridge outlet for dispensing material stored in the cartridge.

The cartridge outlet can comprise one or more cartridge outlet passages. Such cartridge outlet passages enable material stored in a cartridge from being dispensed in a guided manner.

The valve element can be slideably arranged to align the one or more throughbores with the one or more cartridge outlet passages to open the cartridge outlet for dispensing and to misalign the one or more throughbores with the one or more cartridge outlet passages for closing the cartridge outlet. In this connection it should be noted that in the closed position of the valve element the throughbores do not cover any part of the cartridge outlet passages and these are completely covered by a part of the valve element not having the throughbores. In this way the cartridge outlet can beneficially be sealed off from the outside when the valve element is in the closed position.

The valve element can comprise a projection extending in parallel to the longitudinal axis. Preferably the projection extends towards the dispensing outlet in an assembled dispensing system. Such a projection can aid in opening and closing of the valve element during use of the dispensing system. Moreover, such a projection can also help in maintaining the valve element in the closed position before and after use of the dispensing system by providing a seal between the valve element and the cartridge.

The valve element can comprise one or more protrusions extending along the longitudinal axis towards the cartridge. Such protrusions can aid in sealing off the cartridge before and after use of the dispensing system.

The valve element can be received in one or more channels in the cartridge outlet. Such channels can ensure the correct guidance of the valve element during the sliding motion thereof between the closed and open positions.

The projection can be held in one position by a component of the cartridge at the cartridge outlet. In this way the valve element can e.g. be fixed in the closed position during storage of the cartridge of the dispensing system, in order to avoid an accidental opening of the valve element. This fixation can e.g. be brought about by a press-fit, a shape-fit an interference-fit or the like.

The projection can be entrainable by the dispensing outlet to effect the sliding of the valve element. Such a design is simple to manufacture and in use.

At least one of the one or more inlet passages can be configured to entrain at least a part of the valve element, in particular wherein the projection can be entrainable by at least one of the one or more inlet passages. Such a design is simple to manufacture and in use.

The component can comprise one or more arms. Such arms can be used to clamp the projection in the closed position during use of the dispensing system in an as simple as possible manner. For example, the arms can comprise convex surfaces facing the projection that are shaped complementary to an outer shape of the projection in order to cooperate therewith. The projection can be at least part cylindrical in outer shape.

The one or more inlet passages can each comprise one or more wings, with the one or more wings then being configured to engage between the valve element and the component, in particular with a respective wing engaging between a respective arm and the valve element. The provision of wings and arms cooperating with one another at the interface enables a clamping of the dispensing outlet to the cartridge outlet, so that during a dispensing process the cartridge outlet is reliable held at the cartridge outlet.

Each wing can comprise one or more chamfered surfaces. Such chamfered surfaces aid in guiding the dispensing outlet to the cartridge outlet, by so to say allowing these two components to be pulled together.

The one or more protrusions can extend in parallel to a direction of slide of the valve element. In this way the protrusions can aid in guiding the valve element between the open and closed positions.

The one or more protrusions can have a part cylindrical shape. Through the use of curved surfaces a guidance of the valve element in the cartridge outlet can be increased.

The cartridge outlet can comprise one or more channels. The provision of such channels can aid in the connection of the dispensing outlet to the cartridge outlet and/or of the valve element in the interface.

One of the protrusions is received in the one or more channels. In this way the valve element can be beneficially guided in the cartridge outlet.

One of the one or more inlet passages can move relative to the component. E.g. the inlet passages can be locked into position during use of the dispensing system once these have been moved relative to the component, e.g. into an assembled position.

Two components are provided at the cartridge outlet and two inlet passages are provided with each the inlet passage being moveable relative to a respective one of the components, e.g. by into and out of a respective space formed within one of the components. Such components are simple to manufacture The valve element can comprise one or more recesses configured to receive at least a part of the dispensing outlet. Such recesses can ensure a correct placement of the dispensing outlet at the cartridge outlet. Also an engagement between the recess and a part inserted into this can aid in shifting the valve element between the open and closed position and vice versa.

The dispensing system can further comprise a closure ring arranged at the dispensing outlet, with the closure ring comprising a guide slot. Such a closure ring is simple to operate by a user of the dispensing system to rotate the closure ring for locking and unlocking the dispensing outlet to the cartridge and simultaneously guiding the valve element between the open and closed positions.

The projection can be compulsory guided in the guide slot, in particular wherein a rotation of the closure ring can be converted into an axial sliding movement of the valve element via the projection and the guide slot. Such a change of rotational movement into sliding movement by a guide slot ensures that sufficient force for opening and closing of the valve element can be provided.

The guide slot can be integrally formed in the closure ring. Such a design is simple to manufacture and in use.

The guide slot can have a kidney shaped extent. Such a design is simple to manufacture and in use.

The closure ring can comprises a blocking element arranged at an inner surface of the closure ring. Such a blocking element can be used to block a rotation of the closure ring from the open to the closed position, e.g. when no dispensing outlet is attached to the cartridge.

The interface can comprise a rocking element pivotable about a pivot axis. This rocking element can pivot, i.e. rock, about the pivot axis.

The rocking element comprises first and second wings. Such wings can be configured to cooperate with further parts of the interface in different states of use of the dispensing system.

Preferably the rocking element can be brought into and out of engagement with the closure ring, e.g. to block a movement of the closure ring when no dispensing outlet is connected to the cartridge, e.g. by way of the interface.

For this purpose e.g. the second wing can be brought into and out of engagement with the closure ring, e.g. only when a dispensing outlet is inserted into the interface.

The rocking element can be brought into and out of engagement with the blocking element of the closure ring, e.g. the second wing can be brought into and out of engagement with the blocking element.

The interface can comprise a frame, e.g. projecting in the direction of the dispensing outlet. Such a frame can beneficially be used to receive a distributor of the dispensing outlet, in order to form an alignment means formed by an internal shape of the frame, on the one hand, and an external shape of the distributor, on the other hand, with the two respective shapes only allowing the dispensing outlet to be inserted into the frame of the interface in one orientation only The rocking element can pivot between two arms of the frame, with e.g. the first wing of the rocking element adjoining one of the arms of the frame once the distributor is inserted into the interface.

In this connection it should be noted that on insertion into the interface, the distributor can deflect the rocking element, e.g. the first wing of the rocking element which pivots the rocking element out of engagement with the closure ring, e.g. the blocking element of the closure ring, e.g. the second wing is pivoted out of engagement with the blocking element.

The dispensing system can further comprise coded alignment means ensuring the placement of the dispensing outlet at the cartridge outlet in one orientation only. In this way the dispensing outlet can only be placed in one way at the cartridge, ensuring reliable use of the dispensing system.

The inlet passages, the throughbores, and cartridge outlet passages may not be mirror symmetrically arranged with respect to the longitudinal axis. Such an arrangement can provide a specific type of coded alignment means. A further kind of coded alignment means can be provided through a specific design and shape of the distributor, wings and/or arms and spaces formed therebetween.

The cartridge can be a two-component cartridge comprising first and second cartridge chambers and a respective material stored in a respective one of the first and second cartridge chambers only comes into contact with the other one of the respective materials in the dispensing outlet. In this way cross-contamination at the cartridge outlet can be prevented.

According to a further aspect the present disclosure further relates to a dispensing outlet, in particular configured for use with a dispensing system in accordance with the present teaching, i.e. the dispensing outlet can be designed in accordance with one or more of the specific embodiments disclosed herein, the dispensing outlet comprising an outlet, a mixing element arranged in a mixer housing having the outlet arranged coaxially along a longitudinal axis, two inlet passages, with each inlet passage comprising one or more wings. The dispensing outlet has the same advantages as those discussed in connection with the dispensing system.

The dispensing outlet can comprise further features as defined herein.

The dispensing outlet can comprise an IOR attached at an outlet thereof. Such a dispensing outlet permits the correct placement of the dispensing outlet at a point of treatment, for example, at a cavity of a dental patient or the like.

The IOR can comprise an inner surface having one or more inner surface ribs arranged thereat and the outer housing comprising one or more outer side ribs arranged at the outer side. In this way one can position the IOR relative to the housing.

The one or more inner surface ribs and the one or more outer side ribs can extend in parallel to one another. In this way the dispensing outlet becomes more user friendly.

The one or more inner surface ribs can be configured to mesh with the one or more outer side ribs. In this way a pre-defined position of the IOR relative to the housing can be maintained in use of the dispensing outlet.

The one or more inner surface ribs and the one or more outer side ribs can extend in parallel to the longitudinal axis. In this way an as compact as possible dispensing outlet can be formed.

The IOR can comprise an inlet. The inlet can comprise one or more circumferentially extending ribs, preferably two circumferentially extending ribs. In this way an attachment of the IOR at the housing can be facilitated.

The inlet can comprise one or more apertures, preferably two apertures. In such a way a snap-fit connection can be formed that is simpler to manipulate on assembly of the dispensing outlet.

A respective one of the one or more circumferentially extending ribs is are arranged at a respective one of the one or more apertures. In this way a construction size of the dispensing outlet can be minimized.

The respective ones of the one or more apertures can be arranged downstream of the one or more one or more circumferentially extending ribs when viewed from an inlet opening of the inlet of the IOR. In this way a construction size of the dispensing outlet can be minimized.

The inner surface having the one or more inner surface ribs can be arranged at the inlet. In this way a construction size of the dispensing outlet can be minimized.

The IOR is non-removably attached to the outer housing, e.g. via one or more snap fit connections, preferably via two snap-fit connections. In this way a simple to manufacture connection is used that permits both a rotation of the IOR relative to the housing while securing it axially thereto.

The outer housing can comprise a circumferentially extending lip. In this way an as compact as possible dispensing outlet can be formed via which a snap-fit connection is made possible.

The static mixer can comprise a positioning grid that cooperates with two or more positioning grooves arranged within a connector of the static mixer. In this way an alignment between the connector and the components of the static mixer can be ensured.

The housing of the static mixer can comprise an energy carrier, preferably arranged adjacent the positioning grid. In this way an assembly of the dispensing outlet can be simplified.

An inlet manifold of the static mixer comprises a ledge. In this way an assembly of the dispensing outlet can be simplified.

The inlet manifold can be permanently attached to the housing. In this way one can ensure an as compact as possible design even if for filigree components.

The inlet manifold can be permanently attached to the housing via the energy carrier and the ledge. In this way an assembly of the dispensing outlet can be simplified.

The IOR can comprise an inlet receptacle having a body to which a cannula is attached. By way of example, the cannula can be attached to a body at an angle selected in the range of 15 to 75° with respect to a longitudinal axis, especially in the range of 25 to 65° with respect to the longitudinal axis.

By way of example the cannula can have a passage with an internal diameter selected in the range of 0.1 to 2 mm. In contrast to this the diameter of a housing of the mixing element arranged in the dispensing outlet can have an internal diameter selected in the range of 1 to 12 mm.

A length of the cannula can be selected in the range of 5 to 100 mm, especially in the range of 8 to 60 mm.

The dispensing outlet respectively the IOR can further comprising a plate that is connected to the body of the inlet receptacle. Such a plate enables an improved gripping of the dispensing outlet.

The plate can be connected to the body by one or more webs of material. By way of such a connection material can be saved and the plate can be formed in a simple manner.

The dispensing outlet respectively the IOR can further comprise a plate that is then connected to the body of the inlet receptacle via one or more webs at that part of the inlet receptacle where the cannula is attached to the body. Such a plate enables an improved gripping of the dispensing outlet on a use thereof.

The plate can have a flat outer surface. Such a flat outer surface enables an improved gripping of the plate on a use of the dispensing outlet.

According to a further aspect the present disclosure further relates to a cartridge, in particular configured for use with a dispensing system with the present teaching, i.e. the cartridge can be designed in accordance with one or more of the specific embodiments disclosed herein, the cartridge comprising a cartridge outlet, the cartridge outlet comprising a valve element arranged slideably therein, with the valve element being arranged between a base of the cartridge outlet and arms that project inwardly from an outer wall of the cartridge. The cartridge has the same advantages as those discussed in connection with the dispensing system.

### BRIEF DESCRIPTION OF THE DRAWINGS

Further embodiments of the disclosure are described in the following description of the Figures. The disclosure will be explained in the following in detail by embodiments and with reference to the drawing in which is shown:

FIGS. 1A to 1C illustrate various views of a first kind of dispensing system;

FIGS. 2A and 2B are sectional views of the dispensing system of FIGS. 1A to 1C;

FIGS. 3A to 3C are various views of a second kind of dispensing system;

FIGS. 4A and 4B are further views of the dispensing system of FIGS. 3A to 3C;

FIGS. 5A to 5D are various views of a third kind of dispensing system;

FIGS. 6A to 6C are views of an interface of a dispensing system according to FIGS. 1A to 1C;

FIGS. 7A and 7B are further sectional views of the second kind of dispensing system;

FIGS. 8A to 8H are views of a valve element (aside from FIG. 8C);

FIGS. 9A to 9F are views of a dispensing outlet of the second kind of dispensing system;

FIGS. 10A and 10B are views of a cartridge of the second kind of dispensing system;

FIGS. 11A and 11B are views of a cartridge of the second kind of dispensing system;

FIGS. 12a to 12B are various views of a fourth kind of dispensing system;

FIGS. 13A and 13B are a further type of dispensing outlet as a perspective view and as a sectional view;

FIGS. 14A to 14C are views of the intra oral rotational tip of FIGS. 13A and 13B;

FIGS. 15A to 15C are views of a further type of IOR; and

FIGS. 16A to 16D are views of a fifth kind of dispensing system.

### DETAILED DESCRIPTION

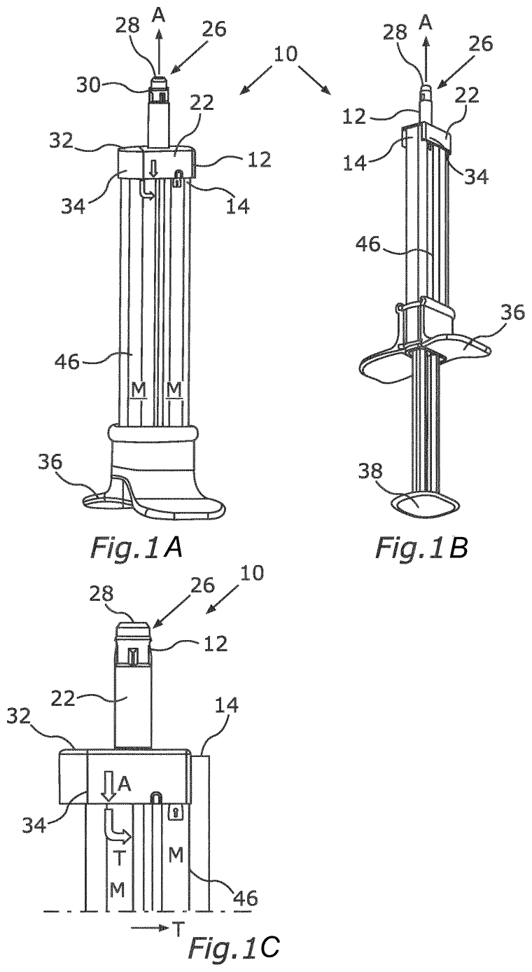

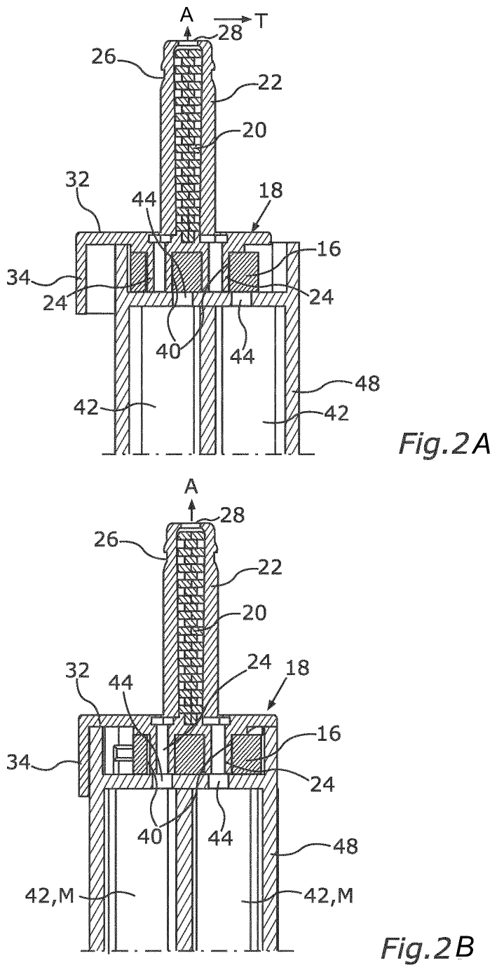

FIG. 1A shows a dispensing system 10 comprising a dispensing outlet 12 connected to a cartridge outlet 14 of a cartridge 48. The dispensing outlet 12 is connected to the cartridge outlet 14 via an interface 18, see e.g. FIG. 2A.

The dispensing outlet 12 comprises a mixer housing 22 having an outlet 28 via which one or more materials M stored in the cartridge 46 can be dispensed. In order to cover the cartridge outlet 14, the dispensing outlet 12 comprises a cover disc 32 that is connected to a collar 34. The collar 34 party surrounds the cartridge outlet 14. As indicated in FIG. 1b the collar 34 surrounds three sides of the cartridge outlet 14.

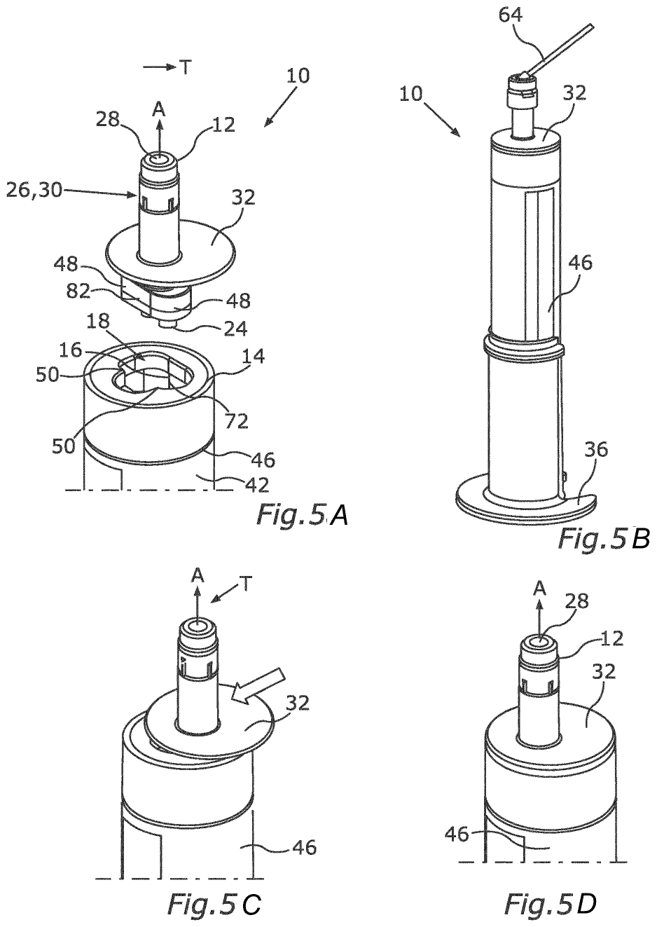

At its end adjacent the outlet 26, the mixer housing 22 comprises a connector 26, e.g. comprising a snap fit component 30 via which a specific type of tip can be connected to the dispensing outlet. By way of example an intra oral rotation tip (IOR) 64 as indicated, e.g. in FIGS. 5A to 5D, 13A and 13B and 14A-14C can be connected to the outlet 28 of the dispensing outlet 12.

The end of the cartridge 48 remote from the cartridge outlet 14 comprises two gripping elements 36 via which the cartridge 46 can be held in use of the dispensing system 10. As indicated in FIG. 1b, a plunger 38 is arranged moveable in the cartridge 46 in order to engage pistons (not shown) for discharging the material M out of the cartridge 46. During use of the dispensing system 100 a user grips the wings with fingers of his hand and can exert a pressure on the plunger 38 with his or her thumb for urging the material M stored in the cartridge 46 out of the cartridge 46.

Upon placing the dispensing outlet 12 at the cartridge 46, the dispensing outlet 12 is moved along a longitudinal axis A of the dispensing outlet 12 towards the cartridge outlet 14. Once the dispensing outlet 12 abuts the cartridge outlet 14 this is then moved in a direction T transverse to the longitudinal axis A as indicated by the arrows provided on the dispensing outlet 12 and the cartridge 46 seen e.g. in FIG. 1c. In this connection it should be noted that the longitudinal axis A of the dispensing outlet 12 is coaxial with the outlet 28 of the dispensing outlet 12.

FIGS. 2A and 2B show sectional views of the dispensing system of FIGS. 1A to 1C. A mixing element 20 is arranged in the mixer housing 22. This mixing element 22 can be of arbitrary shape. By way of example a helical mixing structure can be used, likewise a mixing structure known as a T-Mixing structure or a Quadro mixing structure can be used as the structure of the mixing element 20. Such mixing elements are well known in the art and are used to thoroughly mix multi-component material M.

FIG. 2A shows the dispensing outlet 12 having been axially slid relative to the cartridge outlet 14 along the longitudinal axis A before sliding the dispensing outlet 12 transversely relative to the cartridge outlet.

FIG. 2B shows the assembled dispensing system 10 once the dispensing outlet 12 has also been moved transversely relative to the dispensing outlet 12.

The cartridge 46 has two cartridge chambers 42 for storing a respective material M of a two-component material M, such as a hardener and a corresponding binder.

The respective material M can be dispensed from the respective cartridge chamber 42 via cartridge outlet passages 44.

In the drawing of FIG. 2A, the cartridge outlet passages 44 are closed off, as a valve element 16 covers these. A movement of the dispensing outlet 12 transversely brings about a transverse sliding movement of the valve element 16 relative to the cartridge outlet passages 44 in order to open these by aligning through bores 40 of the valve element 16 with the cartridge outlet passages 44.

In this connection it should be noted that the throughbores 40 are configured to receive a part of an inlet passage 24 of the dispensing outlet 12, with at least one of the one or more inlet passages 24 being configured to entrain the valve element 16 when the dispensing outlet 12 is connected to the cartridge outlet 14.

The inlet passages 24 are configured to guide the respective material M stored in the respective cartridge chamber 42 from the cartridge 46 to the mixing element 20. The inlet passages 24 are aligned with the cartridge outlet passages 44 in the open position of the valve element 16 permitting the guidance of the material M.

In this way the respective material M stored in the respective one of the first and second cartridge chambers 42 only comes into contact with the other one of the respective materials M in the dispensing outlet 12 when the valve element is in the open position leading to an avoidance of cross-contamination at the cartridge outlet 14.

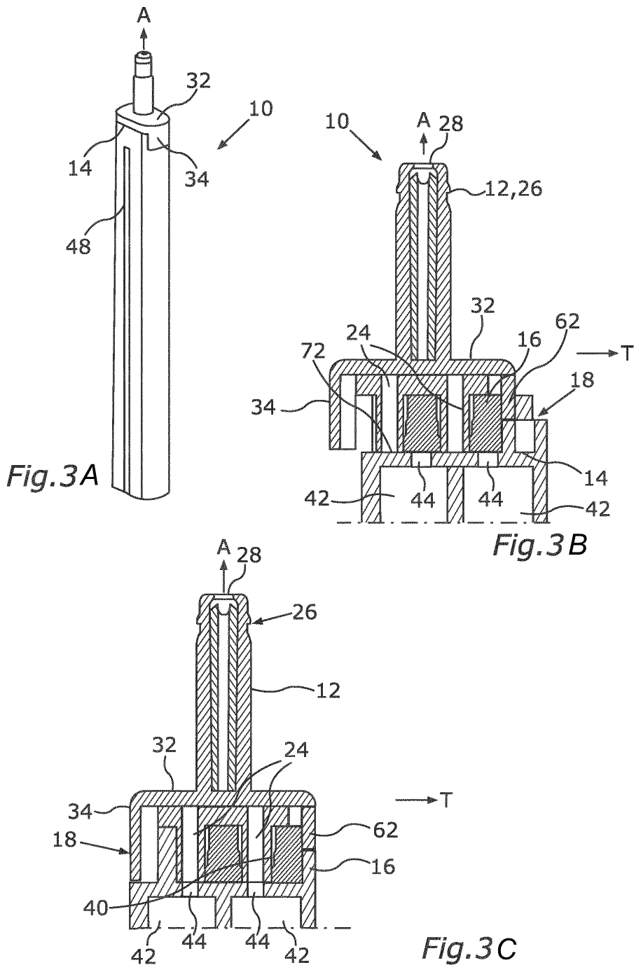

FIGS. 3A to 3C show various views of a second kind of dispensing system 10 similar to those shown in the foregoing in connection with FIGS. 1 and 2.

In contrast to the design shown in FIGS. 1A to 1C and 2A and 2B, the design shown in FIGS. 3A to 3C only has the collar 34 at one side of the dispensing outlet 12 covering one side of the cartridge outlet 14. The valve element 16, the interface 18 and the connector 26 like the mixing element and the housing 22 can be formed identical to one another.

In this connection it should be noted that the collar 34 can cover between 5% and 90% of an outer surface of the cartridge outlet 14, especially can cover between 10% and 75% of the outer surface of the cartridge outlet 14, in other words the collar 34 would then not surround the complete outer surface of the cartridge outlet 14.

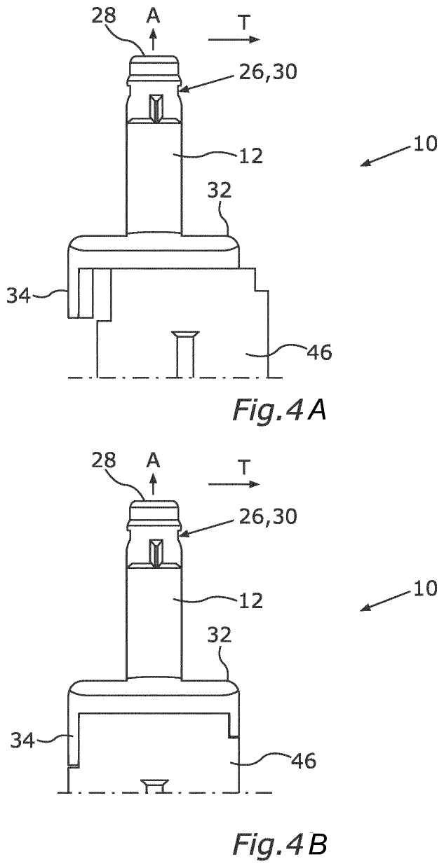

FIGS. 4A and 4B show further views of the dispensing system 10 of FIGS. 3A to 3C highlighting the transverse movement of the dispensing outlet 12 in the direction T transverse to the longitudinal axis A after placement of the dispensing outlet 12 at the cartridge outlet 14.

FIGS. 5A to 5D show various views of a third kind of dispensing system 10, similar to those shown in the foregoing in connection with FIGS. 1A to 1C and 2A and 2B. The difference in design lies therein that the cartridge 46 is of cylindrical shape rather than rectangular shape and that the dispensing outlet 12 only comprises a cover disc 32, but no collar 34.

Also indicated is the valve element 16, which like the valve element of all of the kinds of dispensing system 10 shown herein is not removable from the interface 18 during normal use of the dispensing system. Moreover, like all of the other valve elements shown herein the valve element 16 can only slide relative to the interface 18 along only one axis in the direction T transverse to the longitudinal axis A.

As indicated e.g. in FIG. 4A one part of the dispensing outlet 12 is insertable into valve element 16, namely the inlet passages 24 formed together in a distributor 80 having wings 48.

On sliding the dispensing outlet 12 transversely relative to the cartridge outlet 14 the distributor 80 is clamped between a base 72 of the cartridge outlet 14 and a component having arms 50 of the cartridge outlet 14 in order to avoid an axial movement of the dispensing outlet 12 relative to the cartridge outlet 14 in the open position of the valve element 16.

FIG. 5B shows a perspective view of the third kind of dispensing system 10 of FIG. 5A, FIG. 5C shows the dispensing system with the valve element 16 in the closed position, i.e. before having been slid transversely and FIG. 5D shows the dispensing system 10 once the dispensing outlet 12 has been slid transversely into the open position of the valve element 16.

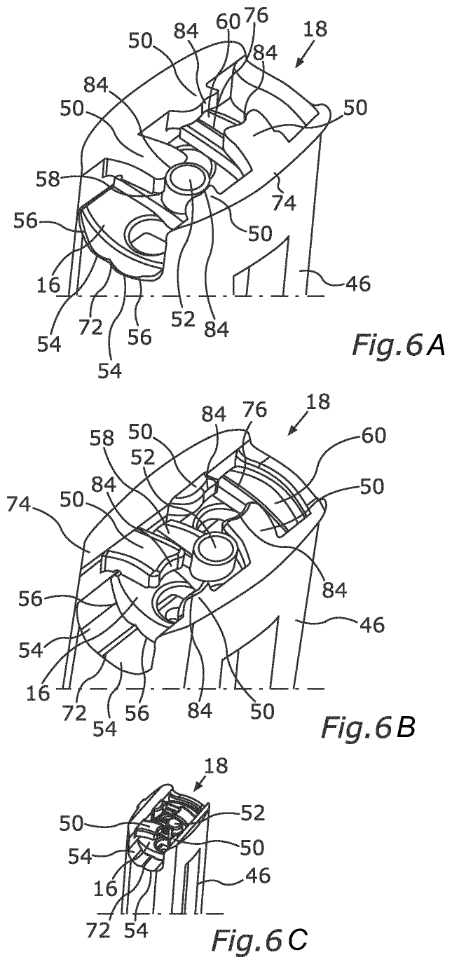

As indicated in FIGS. 6A to 6C, the dispensing the valve element 16 is received in one or more channels 54 in the cartridge outlet 14. These channels 54 are shaped complementary to the valve element 16 in order to facilitate a sliding movement of the valve element 16 relative to the cartridge outlet 14.

As indicated the valve element 16 comprises a projection 52 projecting from the valve element 16 generally in the direction of the longitudinal axis A.

The projection 52 can be held in one position by one component 50 of the cartridge 46 at the cartridge outlet 14 as indicated in FIG. 6A namely between oppositely disposed arms 50 that project into the cartridge outlet 14 from the cartridge walls 74. The arms 50 have an open end 84 which is convexly curved in order to receive the cylindrical shaped projection 52 therein in the closed position of the valve element 16.

The projection 52 is entrainable by the dispensing outlet 12 to effect the sliding of the valve element 16. The part of the dispensing outlet 12 configured to entrain the projection 52 is one of the inlet passages 24 which has a part that is likewise cylindrical in shape and that can be clamped between the convex open ends 84 of oppositely disposed arms 50 in the open position of the valve element 16. Thus, a respective inlet passage 24 can move relative to the component 50.

The valve element comprises protrusions 56 at its side disposed opposite to the side having the projection 52. The protrusions 56 extend in parallel to a direction of slide of the valve element 16. The protrusions 56 have a part cylindrical shape.

A respective one of the protrusions 54 is received in a respective one of the one or more channels 54. The channels 54 are shaped complementary to the protrusions and in this way also ensure a seal between the valve element 16 and the cartridge outlet 14 in the closed position of the valve element 16 As indicated e.g. in FIG. 6A, two components 50 are provided at the cartridge outlet 14 and two inlet passages 24 are provided with each the inlet passage 24 being moveable relative to a respective one of the components 50.

In the closed position of the valve element 16 the curved surfaces of the arms act as hooks hooking the projection 52 therebetween. While the projection 52 is clamped between the arms 50, a first web 58 is clamped between the base of the cartridge outlet 14 and the arms 50 urging the protrusions 56 into sealing engagement with the channels 54. This interference so to say pushes the valve element 16 towards the cartridge outlet to maintain the closed position.

In the open position the valve element 16 is entrained by the inlet passages 24 of the dispensing outlet 14 to slide this transversely relative to the cartridge outlet 14, releasing the projection 52 from the “hooks” formed by the curved surfaces of the open ends 84 of the arms 50. The cylindrical parts of the inlet passages 24 are then positioned between the open ends 84 of the arms 50 and are likewise hooked therebetween assuring a correct locating of the valve element 16 in the cartridge outlet 14.

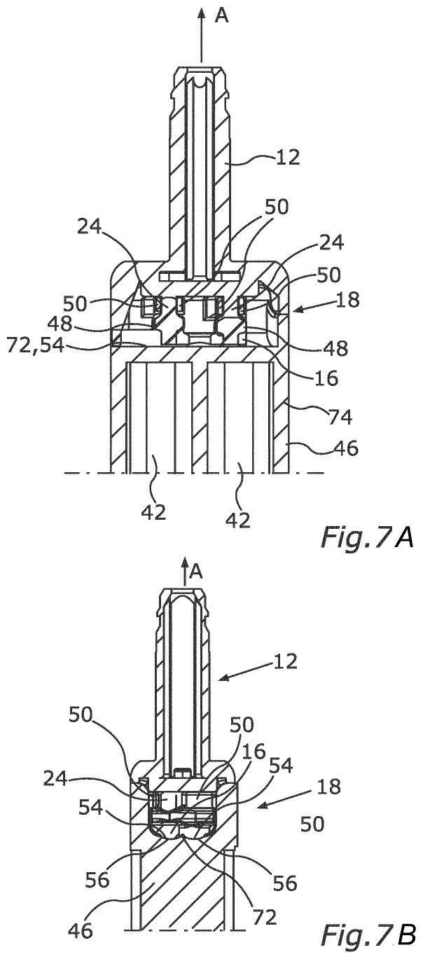

FIGS. 7A and 7B show further sectional views of the second kind of dispensing system 10. As indicated each inlet passage 24 comprises wings 48, with the wings 48 being configured to engage between the valve element 16 and the arms 50. It should be noted in this connection that a respective wing 48 can engage between a respective arm 50 and the valve element 16.

In this connection it should be noted that such wings 48 and arms 50 can be provided at all of the kinds of dispensing systems 10 shown herein.

In order to aid the introduction of the wing 48 respective wing 48 into engagement beneath a respective arm each the wing 48 can comprises one or more chamfered surfaces 78.

These are provided so that while the wings are guided beneath an arm also an axial pressing of the dispensing outlet 12 towards the cartridge outlet 14 can be achieved.

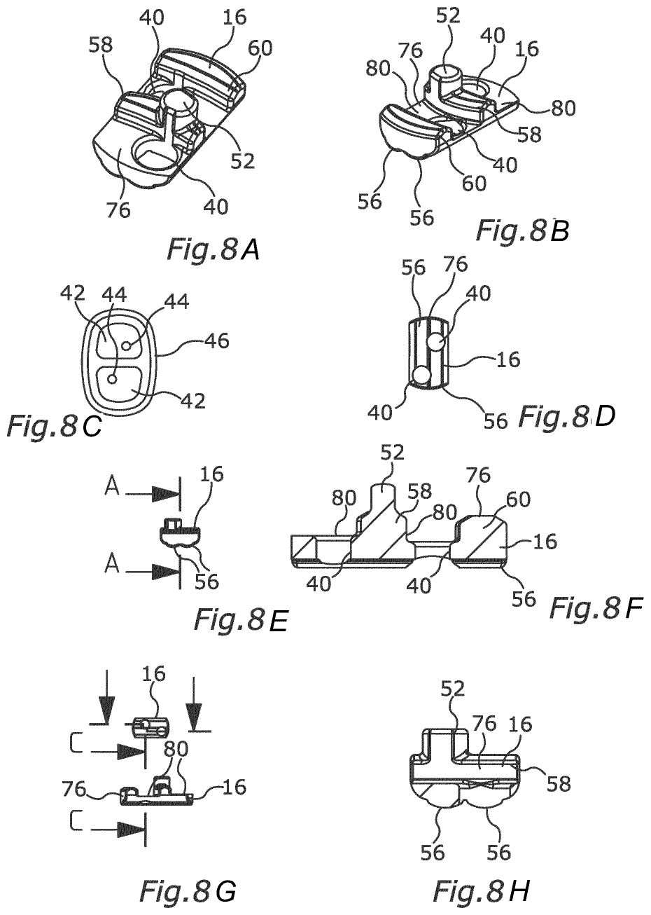

FIGS. 8A to 8H, apart from FIG. 8C, show views of the valve element 16. As indicated the valve element 16 comprises an elongate plate 76 with the throughbores 40.

The valve element 16 comprises two recesses 80 arranged in parallel with the projection 52 that are configured to receive a respective wing associated with one of the inlet passages 24.

The position of these recesses 80 and of the throughbores 40 provide coded alignment means that ensure the correct placement of the dispensing outlet 12 at the cartridge outlet 14 in one orientation only. This is because of the shape and positioning of the respective part.

As indicated in FIGS. 8a and 8c, the throughbores 40, and the cartridge outlet passages 44 are not mirror symmetrically arranged with respect to the longitudinal axis A.

As indicated in FIGS. 8B, 8D, 8F and 8H, the plate shaped valve element 16 has the protrusions 46 arranged at a side of the valve element 16 opposite to the side having the projection, with the troughbores 40 extending between the sides.

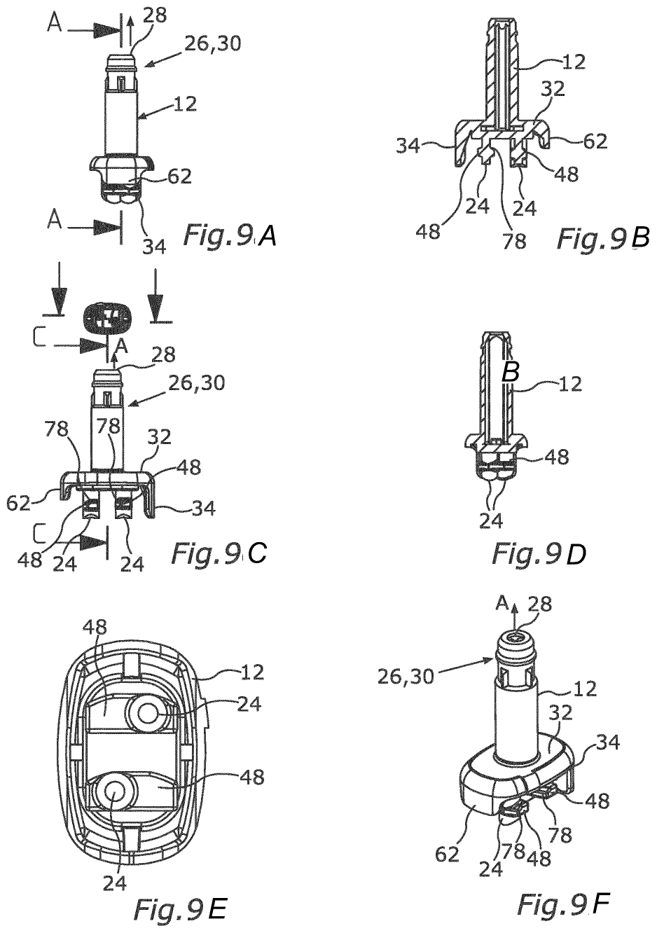

FIGS. 9A to 9F show views of a dispensing outlet of the second kind of dispensing system 10. The inlet passages 24 of the dispensing outlet 12 are likewise not mirror symmetrically arranged with respect to the longitudinal axis A. They are positioned complementary to the throughbores 40, and the cartridge outlet passages 44 in order to ensure a correct positioning of the inlet passages relative to the cartridge outlet passages 44 in the open position of the valve element.

As indicated in the various views the wings 48 project from the inlet passages 24 in a direction perpendicular to the longitudinal axis A.

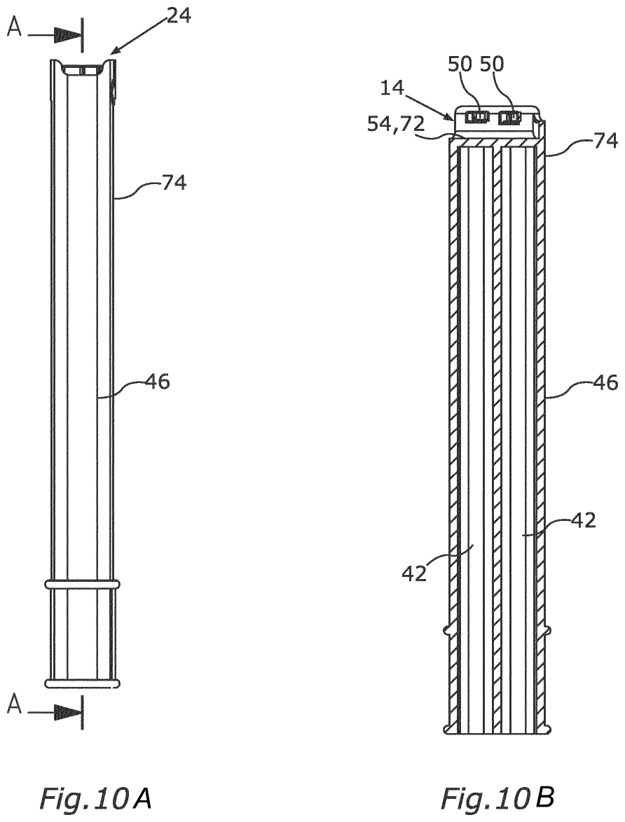

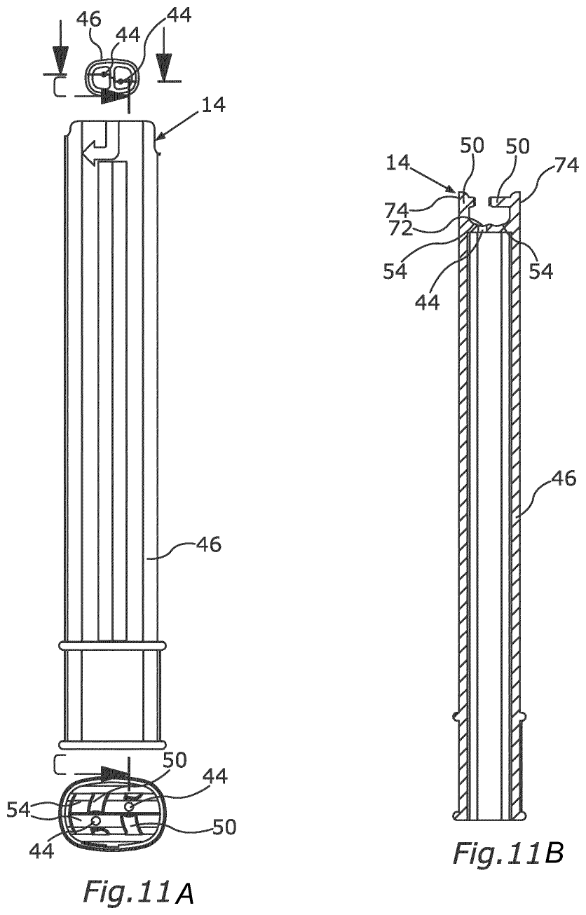

FIGS. 10A and 10B and 11A and 11B show views of a cartridge of the second kind of dispensing system 10. This is configured for use with the cartridge outlet as indicated in FIGS. 9A to 9F in conjunction with the valve element 16 shown in FIGS. 8A to 8H.

The cartridge 46 comprises the cartridge outlet 14 with the valve element 16 being able to be arranged slideably therein. The valve element 16 can be arranged between the base 72 of the cartridge outlet 14 and the arms 50 that project inwardly from an outer wall 74 of the cartridge 46.

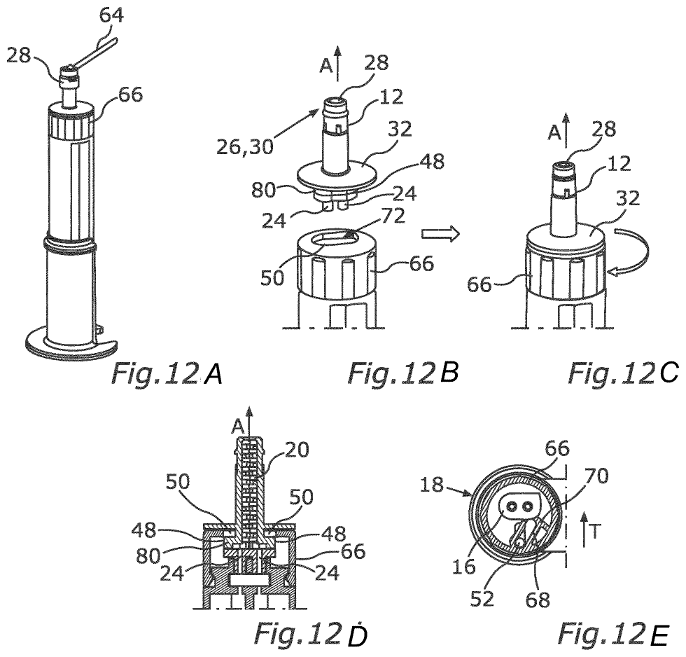

FIGS. 12A to 12E show various views of a fourth kind of dispensing system 10. The dispensing system 10 further comprises a closure ring 66 arranged at the dispensing outlet 12.

The views shown in FIGS. 12A to 12C are similar to those shown in connection with the third kind of dispensing system 10 with the distributor 82 being clampable between the arms 50 and the base 72 of the valve element 16.

FIG. 12D shows the dispensing outlet 14 in the open position of the valve element 16 once the closure ring 66 has been rotated.

FIG. 12E shows the closure ring 66 comprising a guide slot 68 that is integrally formed therewith. In order to hold the guide slot 68 in place a web 70 projects from the inner surface of the closure ring 66.

The projection 52 is compulsory guided in the guide slot 68. During use of the fourth kind of dispensing system 10 a rotation of the closure ring 66 is converted into an axial sliding movement of the valve element 16 via the projection 52 and the guide slot 68 in order to shift the valve element 16 from the closed position into the open position and vice versa.

In order to effect the opening and closing movement of the valve element 16 the guide slot 68 has a kidney shaped extent for guiding the projection 16 of the valve element 16 in the direction T transverse to the longitudinal axis A.

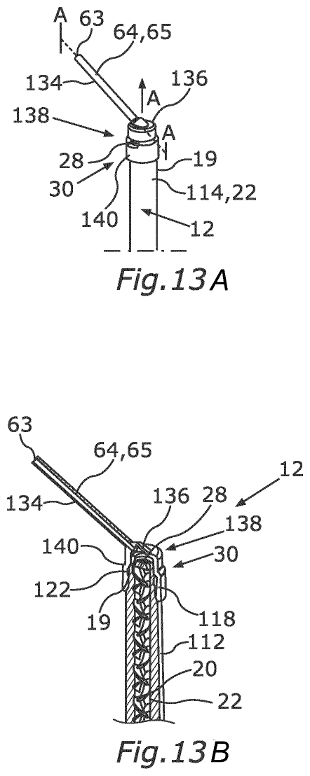

FIGS. 13A and 13B show a further type of dispensing outlet 12. FIG. 13A shows a perspective view of the dispensing outlet 12 and FIG. 13B shows a sectional view taken along the sectional line A: A of FIG. 13A.

The dispensing outlet 12 is configured for use in the dispensing system 10 as shown in the foregoing. The dispensing outlet 12 comprises the mixing element 20 arranged in the housing 22 and the IOR 64. The dispensing outlet 12 can be attached to a cartridge (see e.g. FIG. 5B) via one of the interfaces 18 described in the foregoing in connection with any of the kinds of dispensing systems 10.

The IOR 64 comprises an outlet 63 via which the material is dispensed, with the outlet 63 being at a first end 67 of a cannula 65 of the intra oral rotational tip (IOR) 64. The first end 67 being disposed opposite to a second end 69 of the cannula 65, with the cannula 65 being connected to an inlet receptacle 138 of the IOR 64 at the second end 69.

The cannula 65 comprises a passage 134 for conducting material dispensed from the cartridge 46 via the dispensing outlet 12 into the IOR 64 via the outlet 63 of the IOR 64.

In this connection it should be noted that also other types of connection means differing from the ones described herein can also be employed.

The IOR 64 is attached to an outer side 112 of the housing 22 such that the IOR 64 can rotate relative to the mixing element 20 but cannot be axially moved, i.e. cannot be moved along the longitudinal axis A, but can be rotated about the longitudinal axis A.

The IOR 64 comprises an inlet 118 formed within a body 140 of the inlet receptacle 138 that is arranged at the end 19 of the dispensing element 12, e.g. a static mixer or a dynamic mixer. The end 19 of the dispensing outlet 12 is inserted into the inlet 118 of the inlet receptacle 138 and snap fit into place there via two snap-fit connections 30.

The end 19 of the outer side 112 of the housing 22 comprises a circumferentially extending lip 122. In the example shown in FIG. 13B the lip extends completely around the outer side 112 of the housing 22. It should however be noted that the lip 122 can also comprises two or more part lips (not shown). The function of the lip 122 is to provide a part of the snap fit connection 120 via which the IOR 64 is attached to housing 22. The attachment is selected such that the IOR 64 cannot be removed from the housing 22 during a normal use thereof.

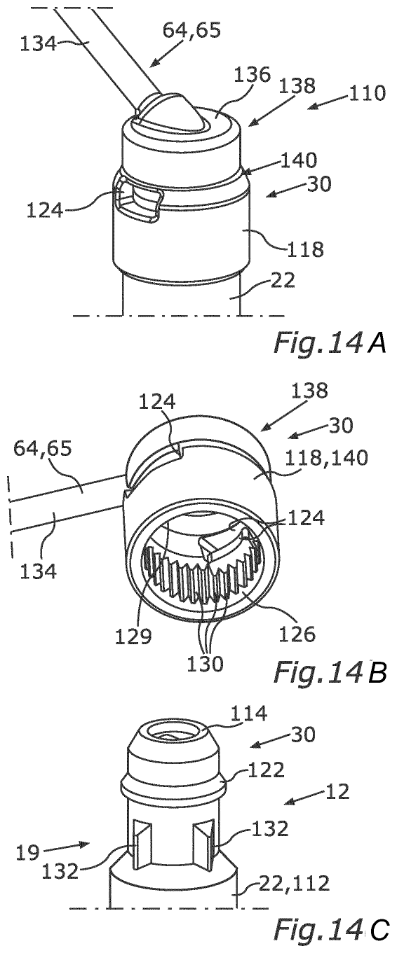

FIGS. 14A to 14C show views of the intra oral rotational tip 64 of FIGS. 13A and 13B. In FIG. 14A the IOR 64 is attached to the dispensing outlet 12. The IOR 64 comprises the inlet receptacle 138 for attachment of the cannula 65 to the dispensing outlet 12.

The end 19 of the outer side 112 of the housing 22 is inserted into the inlet 118.

The inlet 118 further comprises two apertures 124. These apertures 124 form part of the snap-fit connection 30. It should be noted in this connection that the snap-fit connection could also be formed without these apertures 124.

As viewed from an inlet opening 126 of the inlet 118, the inlet 118 comprises two circumferentially extending ribs 128 respectively arranged at one of the apertures 124, with the apertures 124 being arranged downstream of the respective circumferentially extending rib 128 when viewed from the inlet opening 126.

When the IOR 64 is snap-fit into place at the dispensing outlet 12 via the inlet receptacle 138, the two ribs 128 engage behind the circumferential lip 122. The IOR 64 is thereby axially fixed to the dispensing outlet 12.

The inlet 118 of the IOR 64 comprises an inner surface 129 having a plurality of inner surface ribs 130 arranged thereat as shown in FIG. 6B. The inner surface ribs 130 extend in parallel to one another and the longitudinal axis A.

As indicated in FIG. 14C the dispensing outlet 12 has the outlet 28 that is aligned with a passage 134 (see FIG. 14A) of the IOR 64, with the material to be dispensed exiting the outlet 114 and subsequently from the passage 134.

As further indicated in FIG. 14C, the outer side 112 of the housing 22 comprises one or more outer side ribs 132 arranged at the outer side 112. The outer side ribs 132 extend in parallel to one another and to the longitudinal axis A.

The inner surface ribs 130 are configured to mesh with the outer side ribs 132. In this way the IOR 64 can be rotated about the longitudinal axis A and the dispensing outlet 12. The IOR 64 can be positioned relative to the dispensing outlet 12 in dependence on the mesh position.

In this way the IOR 64 of the dispensing outlet 12 can be positioned e.g. at a tooth of a patient to be treated, and the cartridge attached thereto can be rotated by e.g. a dental professional, in order to dispense the material at a desired angle in an expedient manner.

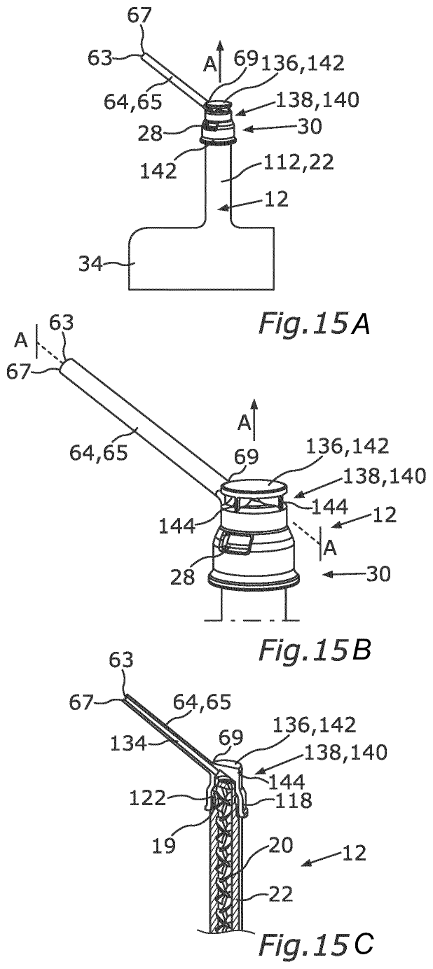

FIGS. 15A to 15C show a further kind of IOR 64 which is connected to the dispensing outlet 12 as taught in connection with FIGS. 1A to 1C. Naturally speaking the IOR can be used in connection with each of the dispensing outlets 12 as taught herein.

A plate 142 is connected to the body 140 of the inlet receptacle 138 via webs at that part of the inlet receptacle 138 where the cannula 65 is attached to the body 140.

The plate 142 has a flat outer surface 146 that acts as a finger positioning aid during a dispensing process such that a user can safely hold the IOR 64 during dispensing at e.g. a patient's tooth.

The plate 142 is connected to the body by one or more webs 144 of material, with the present example having three such webs 144. In this connection it should be noted that between two and six webs 144 can be provided.

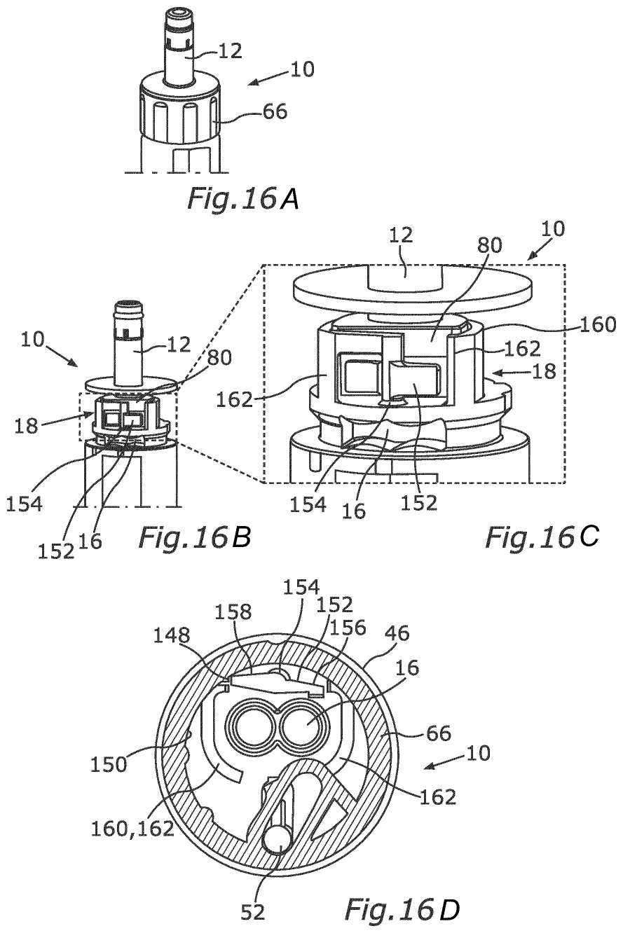

FIGS. 16A to 16C show a further kind of dispensing system 10. This dispensing system 10 is similar to the design shown in connection with FIGS. 12A and 12B.

The difference being provided in that the closure ring 66 comprises a blocking element 148 arranged at an inner surface 150 of the closure ring 66.

The interface 18 further comprises a rocking element 152 pivotable about a pivot axis 154, with the rocking element 152 comprising first and second wings 156, 158.

The rocking element 152 can be brought into and out of engagement with the closure ring 66 by the pivot movement about the pivot axis 154, i.e. the second wing 158 can be brought into and out of engagement with the closure ring 66. Thereby the rocking element 152 can be brought into and out of engagement with the blocking element 148 of the closure ring 66.

The interface 18 further comprises a frame 160, projecting in the direction of the dispensing outlet 12. The frame can be configured to receive the distributor 80 of the dispensing outlet 12. An internal shape of the frame 160 is adapted to an external shape of the distributor 80, with the two respective shapes only allowing the dispensing outlet to be inserted into the frame of the interface in one orientation only, thereby forming coded alignment means.

The rocking element 152 is configured to pivot between two arms 162 of the frame 160, with e.g. the first wing 156 and the second wing 158 of the rocking element 152 respectively adjoining one of the arms 162 of the frame 160 once the distributor 80 is inserted into the interface 18.

In this connection it should be noted that on insertion of the distributor 80 and the inlet passages 24 into the interface 18, a part of the distributor 80 is configured to deflect the rocking element 152, e.g. the first wing 156 of the rocking element 152 which pivots the rocking element 152 out of engagement with the closure ring 66, e.g. the blocking element 148 of the closure ring 66 is then no longer engaged by the second wing 156 as this is pivoted out of engagement with the blocking element 148, in such a manner that the closure ring 66 can be rotated to fix the dispensing outlet to the cartridge 46 and to open the valve element 16.

The multi-component cartridge 46 can thus be filled with materials M selected from the group of members consisting of topical medications, medical fluids, wound care fluids, cosmetic and/or skin care preparations, dental fluids, veterinary fluids, adhesive fluids, disinfectant fluids, protective fluids, paints and combinations of the foregoing.

Such materials M and hence the dispensing system 10 can therefore be expediently used in the treatment of target areas such as the nose (e.g. anti-histaminic creams etc.), ears, teeth (e.g. molds for implants or buccal applications (e.g. aphtas, gum treatment, mouth sores etc.), eyes (e.g. the precise deposition of drugs on eyelids (e.g. chalazion, infection, anti-inflammatory, antibiotics etc.), lips (e.g. herpes), mouth, skin (e.g. anti-fungal, dark spot, acne, warts, psoriasis, skin cancer treatment, tattoo removal drugs, wound healing, scar treatment, stain removal, anti-itch applications etc.), other dermatological applications (e.g. skin nails (for example anti-fungal applications, or strengthening formulas etc.) or cytological applications.

Alternatively the materials M and hence the dispensing system 10 can also be used in an industrial sector both for the production of products as well as for the repair and maintenance of existing products, e.g. in the building industry, the automotive industry, the aerospace industry, in the energy sector, e.g. for wind-turbines, etc. The dispensing system 10 can, for example, be used for the dispensing of construction material, sealants, bonding material, adhesives, paints, coatings and/or protective coatings.

1. A dispensing system comprising:
a dispensing outlet;
a valve element; and
a cartridge having a cartridge outlet with a longitudinal axis extending along the cartridge outlet, the valve element slideably arranged at an interface between the cartridge outlet and the dispensing outlet in a direction transverse to the longitudinal axis, with the valve element being configured to open and close the cartridge outlet to dispense material therefrom, and a part of the dispensing outlet insertable into the interface.

2. The dispensing system in accordance with claim 1, wherein the part of the dispensing outlet is insertable into the interface to slide the valve element in the direction (T) transverse to the longitudinal axis.

3. The dispensing system according to claim 1, wherein the valve element is not removable from the interface.

4. The dispensing system according to claim 1, wherein the valve element is configured to only slide relative to the interface along one axis.

5. The dispensing system according to claim 1, wherein at least the part of or at least one other part of the dispensing outlet is insertable into valve element.

6. The dispensing system according to claim 5, wherein the at least one part comprises one or more inlet passages or wings.

7. The dispensing system according to claim 1, wherein the dispensing outlet comprises a cover disc covering the interface

8. The dispensing system according to claim 1, wherein the dispensing outlet further comprises a collar.

9. The dispensing system according to claim 8, wherein the collar at least partly surrounds the interface and the cartridge outlet.

10. The dispensing system according to claim 8, wherein the collar at least partly surrounds the interface and is arranged at least partly within the cartridge outlet.

11. The dispensing system according to claim 1, wherein the valve element comprises an elongate plate with one or more throughbores.

12. The dispensing system according to claim 11, wherein the one or more throughbores align with the cartridge outlet to open the cartridge outlet for dispensing.

13. The dispensing system according to claim 12, wherein the cartridge outlet comprises one or more cartridge outlet passages.

14. The dispensing system according to claim 13, wherein the valve element is slideably arranged to align the one or more throughbores with the one or more cartridge outlet passages to open the cartridge outlet to dispense and to misalign the one or more throughbores with the one or more cartridge outlet passages to close the cartridge outlet.

15. The dispensing system according to claim 1, wherein the valve element comprises a projection extending in-parallel to the longitudinal axis.

16. The dispensing system according to claim 1, wherein the valve element comprises one or more protrusions extending along the longitudinal axis towards the cartridge.

17. The dispensing system according to claim 1, wherein the valve element is configured to be received in one or more channels in the cartridge outlet.

18. The dispensing system according claim 15, wherein the projection is configured to be held in one position by a component of the cartridge at the cartridge outlet.

19. The dispensing system according to claim 15, wherein the projection is entrainable by the dispensing outlet to effect the sliding of the valve element.

20. The dispensing system according to claim 6, wherein at least one of the one or more inlet passages is configured to entrain the valve element.

21. The dispensing system according to claim 18, wherein the component comprises one or more arms.

22. The dispensing system according to 21, wherein the at least the part of or at least one other part of the dispensing outlet is insertable into valve element, at least one part comprises one or more inlet passages, each of the one or more inlet passages comprises one or more wings, with the one or more wings being configured to engage between the valve element and the component.

23. The dispensing system according to claim 22, wherein each of the wings comprises one or more chamfered surfaces.

24. The dispensing system according to claim 18, wherein the valve element comprises one or more protrusions extending along the longitudinal axis towards the cartridge, and the one or more protrusions extend in parallel to a direction of slide of the valve element.

25. The dispensing system according to claim 24, wherein the one or more protrusions have a part cylindrical shape.

26. The dispensing system according to claim 1, wherein the cartridge outlet comprises one or more channels.

27. The dispensing system according to claim 26, wherein the valve element comprises one or more protrusions extending along the longitudinal axis towards the cartridge, one of the protrusions is received in the one or more channels.

28. The dispensing system according to claim 21, wherein at least the part of or at least one other part of the dispensing outlet is insertable into valve element, the at least one part comprises one or more inlet passages, and one of the one or more inlet passages is configured to move relative to the component.

29. The dispensing system according to claim 21, wherein at least the part of or at least one other part of the dispensing outlet is insertable into valve element, the at least one part comprises first and second inlet passages, and the component is a first component of first and second components provided at the cartridge outlet and the first and second inlet passages are provided with each of said the first and second inlet passages being moveable into and out of a respective one of the first and second components.

30. The dispensing system according to claim 1, wherein the valve element comprises one or more recesses (80) configured to receive at least a part of the dispensing outlet.

31. The dispensing system according to claim 1, further comprising a closure ring arranged at the dispensing outlet, with the closure ring comprising a guide slot.

32. The dispensing system according to claim 31, wherein the valve element comprises a projection extending parallel to the longitudinal axis, and the projection is compulsory guided in the guide slot.

33. The dispensing system according to claim 31, wherein the guide slot is integrally formed in the closure ring.

34. The dispensing system according to claim 31, wherein the guide slot has a kidney shaped extent.

35. The dispensing system according to claim 31, wherein the closure ring comprises a blocking element arranged at an inner surface of the closure ring.

36. The dispensing system according to claim 1, wherein the interface comprises a rocking element pivotable about a pivot axis.

37. The dispensing system according to claim 36, wherein the rocking element comprises first and second wings.

38. The dispensing system according to claim 37, wherein the rocking element is configured to be brought into and out of engagement with a closure ring.

39. The dispensing system according to claim 38, wherein the second wing is configured to be brought into and out of engagement with the closure ring.

40. The dispensing system according to claim 38, wherein the rocking element is configured to be brought into and out of engagement with a blocking element of the closure ring.

41. The dispensing system according to claim 1, wherein the interface comprises a frame.

42. The dispensing system according to claim 41, wherein the interface comprises a rocking element pivotable about a pivot axis, and the rocking element pivots between two arms of the frame.

43. The dispensing system according to claim 1, further comprising a coded alignment element configured to ensure the placement of the dispensing outlet at the cartridge outlet in a single orientation only.

44. The dispensing system according claim 1, wherein the cartridge is a first cartridge of a two-component cartridge, and two-component cartridge comprising first and second cartridge chambers and a first and second materials stored in the first and second cartridge chambers, respectively, with the first and second materials only contacting the other one of the first and second materials in the dispensing outlet.

45. The dispensing system according to claim 13, wherein at least the part of or at least one other part of the dispensing outlet is insertable into valve element, the at least one part comprises first and second inlet passages, the inlet passages, the throughbores, and cartridge outlet passages are not mirror symmetrically arranged with respect to the longitudinal axis.

46. A cartridge configured for use with the dispensing system in accordance with claim 1, the cartridge comprising:
the cartridge outlet comprising the valve element arranged slideably therein, with the valve element being arranged between a base of the cartridge outlet and arms that project inwardly from an outer wall of the cartridge.

47. A dispensing outlet configured for use with a dispensing system in accordance with claim 1, the dispensing outlet comprising:
an outlet;
a mixing element arranged in a mixer housing having the outlet arranged coaxially along the longitudinal axis, two inlet passages with each of the two inlet passages comprising one or more wings.

48. The dispensing outlet in accordance with claim 47, further comprising an IOR attachable at an outer side of the mixer housing such that the IOR is rotatable relative to the dispensing outlet but cannot be axially moved.

49. The dispensing outlet according to claim 48, wherein the IOR comprises an inner surface having one or more inner surface ribs arranged thereat and the outer side of the mixer housing comprising one or more outer side ribs arranged at an outer side.

50. The dispensing outlet according to claim 49, wherein the one or more inner surface ribs and the one or more outer side ribs extend in parallel to one another.

51. The dispensing outlet according to claim 49, wherein the one or more inner surface ribs are configured to mesh with the one or more outer side ribs.

52. The dispensing outlet according to claim 49, wherein the one or more inner surface ribs and the one or more outer side ribs extend in parallel to the longitudinal axis.

53. The dispensing outlet according to claim 48, wherein the IOR comprises an inlet.

54. The dispensing outlet according to claim 53, wherein the inlet comprises one or more circumferentially extending ribs.

55. The dispensing outlet according to claim 54, wherein the inlet comprises one or more apertures.

56. The dispensing outlet according to claim 55, wherein a respective one of the one or more circumferentially extending ribs is arranged at a respective one of the one or more apertures.

57. The dispensing outlet according to claim 56, wherein the respective one of the one or more apertures is arranged downstream of the respective one of the one or more circumferentially extending ribs when viewed from an inlet opening of the inlet of the IOR.

58. The dispensing outlet according to claim 49, wherein the IOR comprises an inlet, and the inner surface has the one or more inner surface ribs is arranged at the inlet.

59. The dispensing outlet according to claim 49, wherein the IOR is non-removably attached to the outer side of the housing.

60. The dispensing outlet according to claim 49, wherein the IOR is non-removably attached to the outer side of the mixer housing via one or more snap fit connections.

61. The dispensing outlet according to claim 49, wherein the outer side of the mixer housing comprises a circumferentially extending lip.

62. The dispensing outlet according to claim 48, wherein the dispending element is a static mixer comprising a positioning grid cooperating with two or more positioning grooves arranged within the valve element.

63. The dispensing outlet according to claim 48, wherein the outer side of the mixer housing comprises an energy carrier.

64. The dispensing outlet according to claim 63, wherein an inlet manifold of the dispensing outlet comprises a ledge.

65. The dispensing outlet according to claim 64, wherein the inlet manifold is permanently attached to the outer side of the mixer housing.

66. The dispensing outlet according to claim 65, wherein the inlet manifold is permanently attached to the housing via the energy carrier and the ledge.

67. The dispensing outlet according to claim 48, wherein the IOR comprises an inlet receptacle having a body to which a cannula is capable of being attached.

68. The dispensing outlet according to claim 67, further comprising a plate connected to the body of the inlet receptacle.

69. The dispensing outlet according to claim 68, wherein the plate is connected to the body by one or more web of material.

70. The dispensing outlet according to claim 69, wherein, the plate (142) that is connected to the body via the one or more webs at that part of the inlet receptacle where the cannula is to be attached to the body.

71. The dispensing outlet according to claim 68, wherein the plate has a flat outer surface.
